(19) United States
(12) Patent Application Publication
(10) Pub. No.: US 2011/0145700 A1
(43) Pub. Date: Jun. 16, 2011

(54) STRUCTURED DOCUMENT ANALYSIS APPARATUS AND STRUCTURED DOCUMENT ANALYSIS METHOD

(75) Inventor: Keisuke Tamiya, Kawasaki-shi (JP)

(73) Assignee: CANON KABUSHIKI KAISHA, Tokyo (JP)

(21) Appl. No.: 12/967,993

(22) Filed: Dec. 14, 2010

(30) Foreign Application Priority Data
Dec. 16, 2009 (JP) 2009-285688

(51) Int. Cl. G06F 17/21

(52) U.S. Cl. 715/242

(57) ABSTRACT

When a structured document includes a compressed structure channel, a structured document analysis apparatus decompresses the structure channel. The structured document analysis apparatus generates an event list including structure information (events) of the structured document, and reference information (block numbers, channel numbers, value numbers) that refers to values. The structured document analysis apparatus notifies an application program of contents of the event list. Subsequently, when the user application requests a value, if the value is compressed, the structured document analysis apparatus decompress the value and notifies the application program of the value.

### BACKGROUND OF THE INVENTION

1. Field of the Invention

The present invention relates to a structured document analysis apparatus and a structured document analysis method.

2. Description of the Related Art

Conventionally, Extensible Markup Language (XML), specifications of which are designed by the World Wide Web Consortium (W3C), has been used as a language to describe structured documents. Based on XML, document components (nodes) such as elements, attributes, and namespaces are used to describe structured documents.

However, a document described in XML often includes redundant and repetitive character strings. Thus, Japanese Patent Application Laid-Open No. 2001-67348 discusses a technique to compress a structured document by tokenizing character strings thereof. Additionally, while an XML document is described in text format, a technique referred to as binary XML technique in which the same document is expressed and compressed in binary format has been discussed. A typical format of the binary XML technique is Fast Infoset (ITU-T X.891) format standardized by the International Telecommunication Union Telecommunication Standardization Sector (ITU-T) (see ITU-T Rec. X.891|ISO/IEC 24824-1). Another typical example is Efficient XML Interchange (EXI) format, of which specifications are being designed by the W3C.

In particular, the specifications of the EXI format define EXI compression format. Based on the EXI compression format, first, a document is compressed by tokenizing character strings, for example. Next, the nodes in the document are divided into structure definitions and values. Next, the structure definitions and the values are collected as separate data groups (channels), and deflate compression is executed on the groups (channels).

When a document analysis module (hereinafter referred to as an XML parser) analyzes a compressed XML document (e.g., an XML document in EXI compression format), before starting analysis, the XML parser needs to decompress all the data of the deflate-compressed document. However, decompressing deflate-compressed data is heavy load on the XML parser on a small device having limited resources in CPU speed, memory capacity, and the like. In many cases, an application program that uses the XML parser to acquire information about the XML document does not need information about the entire XML document at once when the XML parser starts analysis of the XML document. Namely, conventionally, when an XML parser on a small device starts analysis of a compressed structured document (e.g., an XML document), the XML parser is required to execute heavy load processing, that is, decompression of all the document data at once including data not yet needed by a user application such as an application program.

### SUMMARY OF THE INVENTION

The present invention is directed to reduction of processing load caused during analysis of a compressed structured document.

According to an aspect of the present invention, a structured document analysis apparatus for analyzing a compressed structured document including a structure data group having structure information of the document and a value data group having value data corresponding to the structure information includes a structure analysis unit configured to decompress the structure data group to acquire the structure information, a structure notification unit configured to notify software that processes the structured document of the structure information and reference information that refers to the value data, a value selection unit configured to select, when the software specifies the reference information and requests the value data, a value data group of the structured document based on the specified information, a value acquisition unit configured to decompress the value data group selected by the value selection unit to acquire value data, and a value notification unit configured to notify the software of the value data acquired by the value acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a structured document analysis apparatus according to a first exemplary embodiment of the present invention.

FIGS. 2A to 2D illustrate document structures of a structured document.

FIG. 3 illustrates a value channel list.

FIG. 4 illustrates an event list.

FIG. 5 is a flow chart illustrating an overall flow of document analysis processing.

FIG. 6 is a flow chart illustrating detailed operations of step S205 in FIG. 5.

FIG. 7 is a flow chart illustrating detailed operations of step S210 in FIG. 5.

FIG. 8 illustrates a configuration of a structured document analysis apparatus according to a second exemplary embodiment of the present invention.

FIG. 9 illustrates a character string table list.

FIG. 10 illustrates a character string table.

FIG. 11 is a flow chart illustrating detailed operations of step S210 in FIG. 5.

FIG. 12 is a flow chart illustrating detailed operations of step S912 in FIG. 11.

### DESCRIPTION OF THE EMBODIMENTS

Various exemplary embodiments, features, and aspects of the invention will be described in detail below with reference to the drawings.

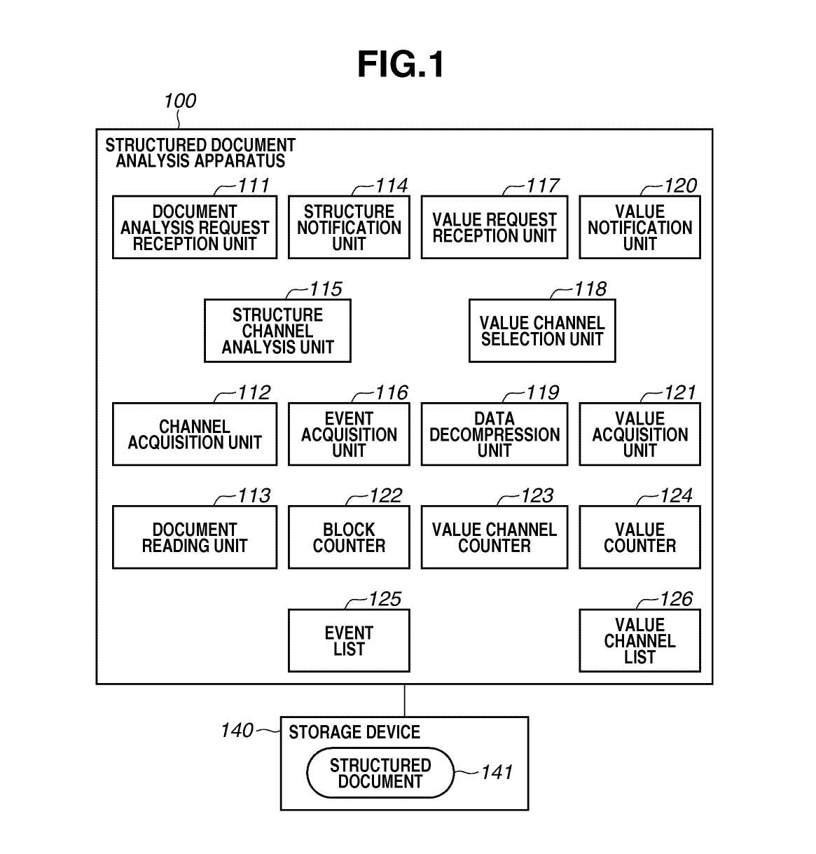

FIG. 1 is a block diagram illustrating a configuration of a structured document analysis apparatus 100 according to a first exemplary embodiment of the present invention.

In FIG. 1, the structured document analysis apparatus 100 includes a CPU, a memory, an input unit, a display unit, a communication unit, and the like (not illustrated). A storage device 140 and the structured document analysis apparatus 100 are mutually connected to each other via a cable. The structured document analysis apparatus 100 can be realized by a personal computer or the like. The structured document analysis apparatus 100 may include the storage device 140. The CPU of the structured document analysis apparatus 100 reads programs stored in the memory to realize the first exemplary embodiment and executes processing relating to each of the following units. The storage device 140 stores a compressed structured document 141 to be analyzed. The structured document analysis apparatus 100 includes a document analysis request reception unit 111 receiving a document analysis request from software such as an application program (hereinafter referred to as “user application” as needed) that processes the structured document 141. The structured document analysis apparatus 100 may include the user application. Alternatively, an apparatus connected to the structured document analysis apparatus 100 via a network may include the user application. In addition, the structured document analysis apparatus 100 includes a channel acquisition unit 112 acquiring data groups referred to as channels from the structured document 141. There are two types of channels: a structure channel and a value channel. The structure channel is a structure data group formed by collection of data units (events) as document structure information defining the structure of a document, and the value channel is a value data group formed by collection of values of the events.

In addition, the structured document analysis apparatus 100 includes a document reading unit 113 reading the structured document 141 from the storage device 140. In addition, the structured document analysis apparatus 100 includes a structure notification unit 114 notifying the user application of events. For example, the structure notification unit 114 calls functions of an application program interface (API), such as Simple API for XML (SAX) or Document Object Model (DOM), of the XML parser requesting an XML structure. In addition, the structured document analysis apparatus 100 includes a structure channel analysis unit 115 analyzing the structure channel of the structured document 141. Further, the memory includes an event acquisition unit 116 acquiring events described in the structure channel.

In addition, the structured document analysis apparatus 100 includes a value request reception unit 117 receiving a request for an event value from the user application. Further, the structured document analysis apparatus 100 includes a value channel selection unit 118 selecting a value channel including a requested event value. In addition, the structured document analysis apparatus 100 includes a data decompression unit 119 decompressing deflate-compressed channels. Further, the memory includes a value notification unit 120 notifying the user application of values of requested events. For example, the value notification unit 120 calls functions of API, such as SAX or DOM, of an XML parser requesting attribute values and element contents.

In addition, the structured document analysis apparatus 100 includes a value acquisition unit 121 acquiring event values from value channels. Further, the structured document analysis apparatus 100 includes a block counter 122 determining the number of channel groups referred to as blocks read from the structured document 141. Further, the memory in the structured document analysis apparatus 100 includes a value channel counter 123 determining the number of value channels read from the structured document 141. The memory also includes a value counter 124 determining the number of values read from the value channels. Further, the memory includes an event list 125 in which a read structured channel is registered. Furthermore, the memory includes a value channel list 126 in which read value channels are registered.

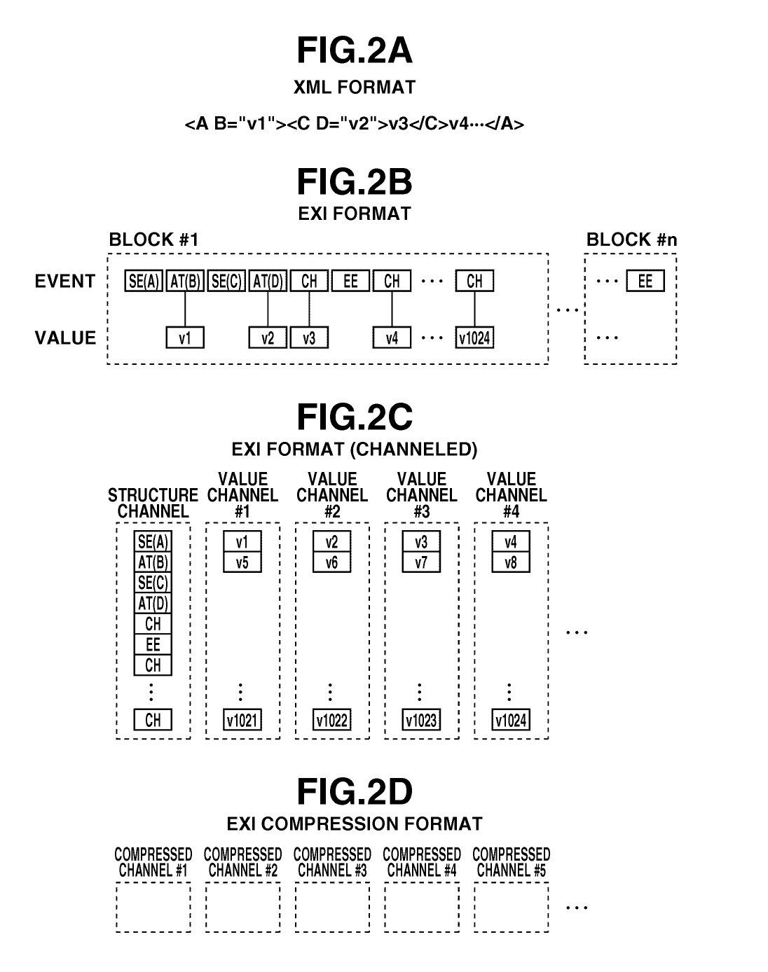

FIGS. 2A to 2D illustrate document structures of the compressed structured document 141. More specifically, the structured document 141 is in EXI compression format of the W3C. FIG. 2A illustrates a structured document in XML format before compression. A document in XML format is described based on document structure units such as elements (A, C), attributes (B, D), element contents (v3, v4), and attribute values (v1, v2). FIG. 2B illustrates the structured document of FIG. 2A in EXI format. In EXI format, the elements (A, C), the attributes (B, D), the element contents (v3, v4), and the attribute values (v1, v2) of the XML document are expressed as events and values. Examples of the event type include:
SE (e): Start Element e
AT (a): Attribute a
CH: Element Content
EE: End Element

FIG. 2C illustrates the structured document of FIG. 2B in EXI format formed into channels. When a structured document is changed from EXI format to EXI compression format, the events of the document are arranged as a single structure channel, and the values are arranged as a plurality of value channels per event type. Rearrangement of the contents of the structured document is executed for each group referred to as a block formed by events and values. In EXI format, values included in a single block can be defined for each structured document as a block size. FIG. 2D illustrates the structured document of FIG. 2C in EXI compression format. The structure channel and the value channels are deflate-compressed, and each of the channels is stored as a single compressed channel. To be more exact, in EXI compression format, if the structured document of FIG. 2C includes channels having a short data size, the channels may be deflate-compressed collectively as a single compressed channel. However, in FIGS. 2A to 2D, for ease of description, a single compressed channel includes a single channel.

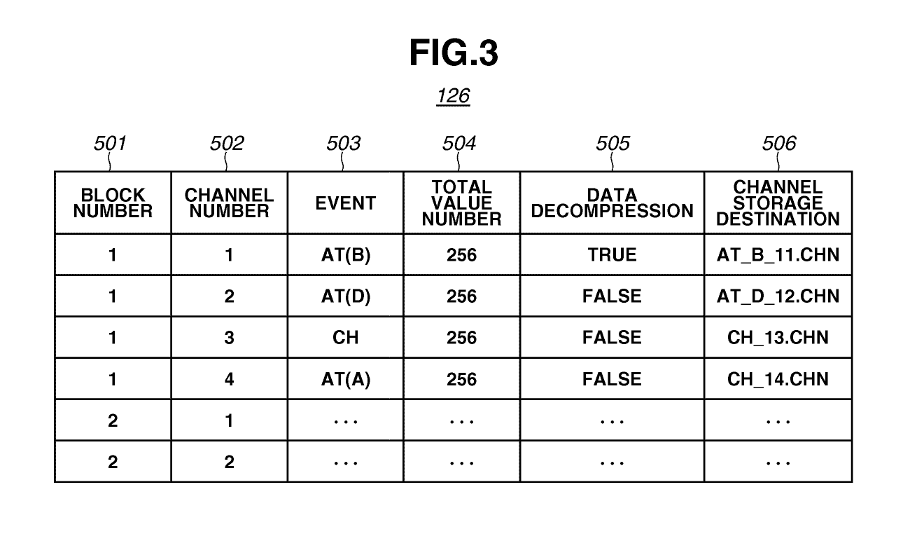

FIG. 3 illustrates the value channel list 126. In FIG. 3, the value channel list 126 includes a block number column 501 indicating the block number of an arbitrary value channel. In addition, the value channel list 126 includes a channel number column 502 indicating the number of an arbitrary value channel in a respective block. Further, the value channel list 126 includes an event column 503 indicating an event to which a value included in a value channel corresponds.

Further, the value channel list 126 includes a total value number column 504 indicating the number of values in an arbitrary value channel. Further, the value channel list 126 includes a data decompression column 505 indicating whether data of an arbitrary value channel has already been decompressed. In FIG. 3, TRUE in this column indicates that data of the value channel has already been decompressed. In contrast, FALSE in this column indicates that data of the value channel has not been decompressed yet.

Additionally, the value channel list 126 includes a channel storage destination column 506 indicating value channel storage locations. In FIG. 3, file names are used as the value channel storage locations. However, arbitrary information may be used as the value channel storage locations, as long as storage locations can be identified. For example, file pointers, memory addresses, or uniform resource locators (URLs) may be used. In the value channel list 126, information in the above columns is mutually associated and registered.

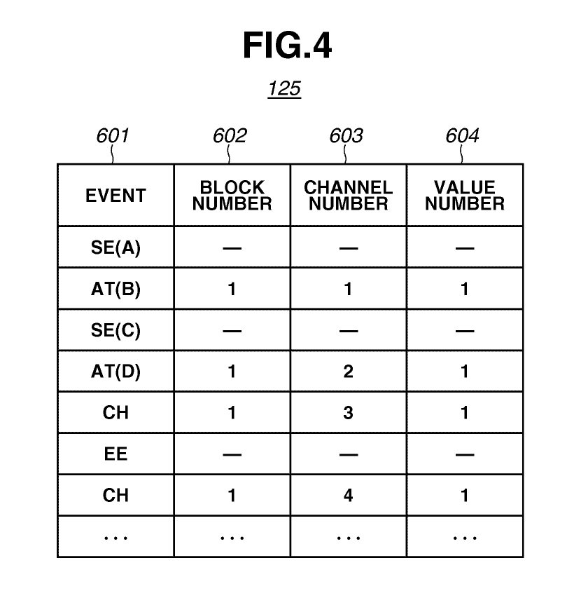

FIG. 4 illustrates the event list 125. The event list 125 includes an event column 601 in which the events included in the structure channel of the structured document 141 are arranged in order. Further, the event list 125 includes a block number column 602. If an event has a value, the block number column 602 indicates the block number corresponding to the value channel including the value. In a structured document in EXI format, attribute AT (x) events (x is an attribute name) and element content CH events have values. In addition, the event list 125 includes a channel number column 603. If an event has a value, the channel number column 603 indicates the number of the value channel including the value in a respective block. Further, the event list 125 includes a value number column 604 indicating the number of the value of the event in a respective value channel. In the event list 125, information in the above columns is mutually associated and registered.

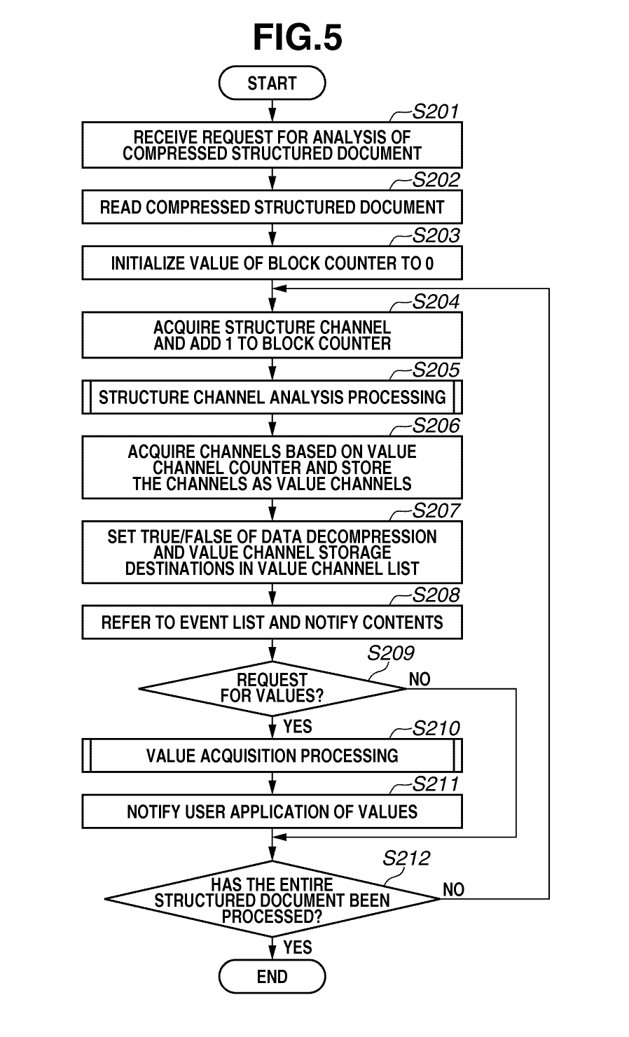

Next, an overall flow of document analysis processing executed by the structured document analysis apparatus 100 will be described with reference to the flow chart of FIG. 5. In step S201, the document analysis request reception unit 111 receives a request for analysis of the compressed structured document 141. Next, in step S202, the document reading unit 113 reads the structured document 141. In step S203, after reading the structured document 141, the document reading unit 113 initializes a value of the block counter 122 to 0. After the document reading unit 113 initializes the value of the block counter 122, the structured document analysis apparatus 100 executes the following processing (steps S204 to S212) on all the blocks included in the structured document 141.

In step S204, first, the channel acquisition unit 112 acquires a structure channel from the structured document 141 and adds 1 to the block counter 122. The first channel of each block of a structured document in EXI format is a structure channel. Next, in step S205, the structured document analysis apparatus 100 executes structure channel analysis processing to analyze the structure channel acquired in step S205. Through this structure channel analysis processing, the number of value channels included in the block to which the structure channel acquired in step S205 belongs is set in the value channel counter 123. In addition, through this structure channel analysis processing, the block number column 501, the channel number column 502, the event column 503, and the total value number column 504 in the value channel list 126 are set. The structure channel analysis processing will be described in detail below.

In step S206, the channel acquisition unit 112 acquires applicable channels based on the number of value channels set in the value channel counter 123 from the structured document 141 and stores the acquired channels as value channels in files. In step S207, after storing the value channels, the channel acquisition unit 112 sets TRUE/FALSE in the data decompression column 505 and file names in the channel storage destination column 506 in applicable rows of the value channel list 126. Next, in step S208, the structure notification unit 114 refers to the event list 125 and notifies a user application of contents thereof. Next, in step S209, the value request reception unit 117 determines whether to have received a request for values, in addition to the block numbers, the value channel numbers, and the value numbers. If the value request reception unit 117 has received a request for values (YES in step S209), then in step S210, the value acquisition unit 121 executes value acquisition processing to acquire the requested values. Next, in step S211, the value notification unit 120 notifies the user application of the acquired values. If the value request reception unit 117 has not received a request for values (NO in step S209), steps S210 and S211 are skipped and the operation proceeds to step S212. Next, instep S212, the channel acquisition unit 112 determines whether the entire structured document 141 has been processed. If the entire structured document 141 has not been processed yet (NO in step S212), the operation returns to step S204 and the structured document analysis apparatus 100 executes the above processing on the next block. If the entire structured document 141 has been processed (YES in step S212), the structured document analysis apparatus 100 ends the processing illustrated by the flow chart of FIG. 5.

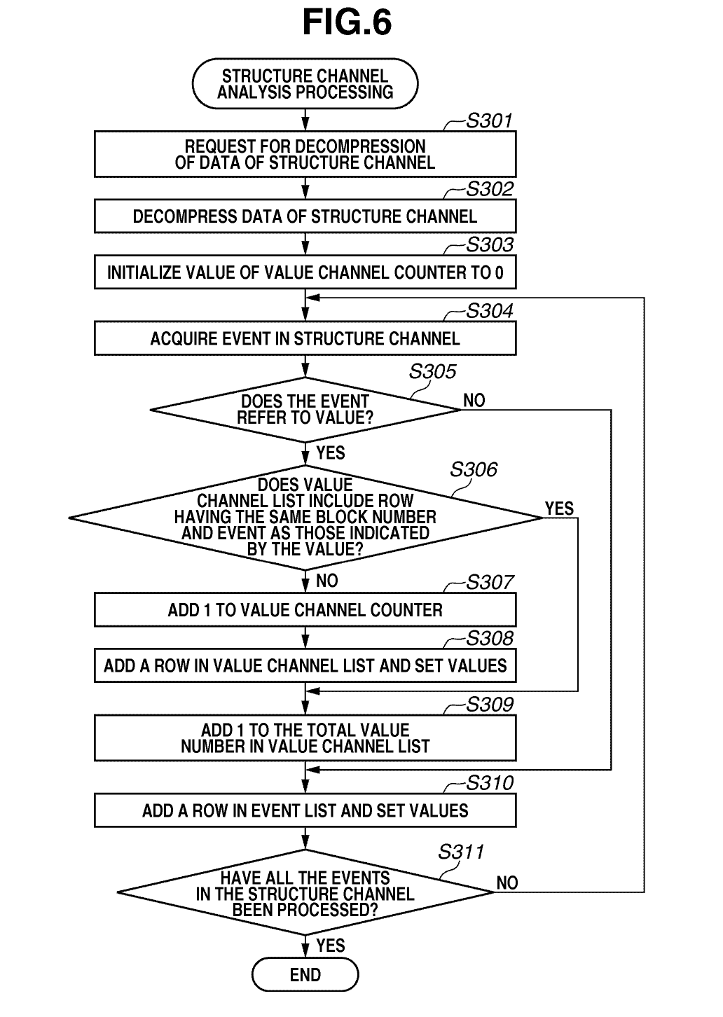

Next, the structure channel analysis processing in step S205 of FIG. 5 will be described in detail with reference to the flow chart of FIG. 6. First, in step S301, the structure channel analysis unit 115 requests the data decompression unit 119 to decompress data of the structure channel acquired in step S205. Next, in step S302, the data decompression unit 119 decompresses data of the structure channel. In step S303, after the data decompression, the structure channel analysis unit 115 initializes a value of the value channel counter 123 to 0. Next, the structured document analysis apparatus 100 executes the following processing (steps S304 to S311) on all the events included in the structure channel.

First, in step S304, the event acquisition unit 116 acquires a single event in the structure channel. Next, in step S305, the event acquisition unit 116 determines whether the acquired event refers to a value. As described above, in a structured document in EXI format, attribute AT (x) events (x is an attribute name) and element content CH events have values. If the acquired event refers to a value (YES in step S305), the operation proceeds to step S306. On the other hand, if the acquired event does not refer to a value (NO in step S305), the operation proceeds to step S310.

If the acquired event refers to a value (YES in step S305), then in step S306, the event acquisition unit 116 refers to the value channel list 126. More specifically, in step S306, the event acquisition unit 116 determines whether the value channel list 126 includes a row in which the value in the block number column 501 matches the value of the block counter 122 and the value in the event column 503 matches the value of the acquired event. If the value channel list 126 includes an applicable row (YES in step S306), the operation proceeds to step S309, and if not (NO in step S306), the operation proceeds to step S307. Instep S307, the structure channel analysis unit 115 adds 1 to the value channel counter 123.

Next, in step S308, the structure channel analysis unit 115 adds a row in the value channel list 126 and sets the value of the block counter 122, the value of the value channel counter 123, and the acquired event in the block number column 501, the channel number column 502, and the event column 503 in the added row, respectively. In addition, the structure channel analysis unit 115 sets initial values (0, FALSE, and NULL, for example) in the total value number column 504, the data decompression column 505, and the channel storage destination column 506 in the added row. Next, in step S309, the structure channel analysis unit 115 adds 1 to the total value number column 504 in the corresponding row in the value channel list 126.

Next, in step S310, the structure channel analysis unit 115 adds a row corresponding to the event acquired in step S304 in the event list 125. The structure channel analysis unit 115 sets the acquired event in the event column 601 in the added row. If the acquired event refers to a value, the structure channel analysis unit 115 sets, in the block number column 602 of the added row, the value of the block number 501 in the corresponding row of the value channel list 126. Further, the structure channel analysis unit 115 sets, in the channel number column 603 of the added row, the value of the channel number 502 in the corresponding row of the value channel list 126. The structure channel analysis unit 115 also sets, in the value number column 604 of the added row, the current total value number 504 in the corresponding row of the value channel list 126.

Next, in step S311, the event acquisition unit 116 determines whether all the events in the structure channel have been processed. If not all the events in the structure channel have yet been processed (NO in step S311), the operation returns to step S304 and the structured document analysis apparatus 100 executes the above processing on the events that have not been acquired yet. On the other hand, if all the events in the structure channel have been processed, the structured document analysis apparatus 100 ends the processing illustrated by the flow chart of FIG. 6.

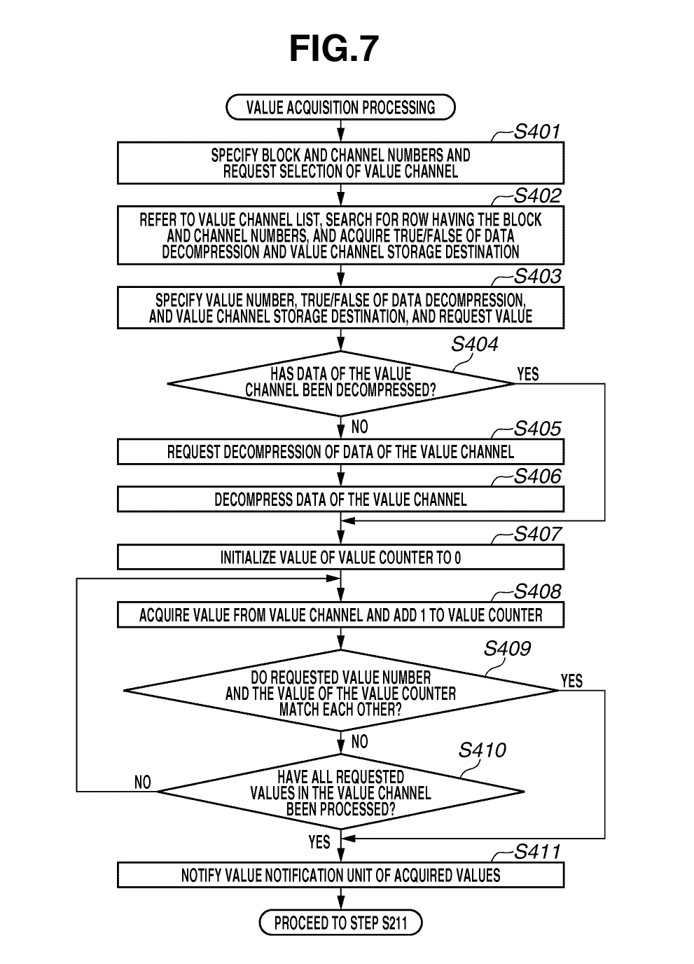

Next, the value acquisition processing in step S210 of FIG. 5 will be described in detail with reference to the flow chart of FIG. 7. First, in step S401, the value request reception unit 117 specifies the requested block number and channel number and requests the value channel selection unit 118 to select a value channel. Upon receiving a request, the value channel selection unit 118 refers to the value channel list 126 and searches for a row corresponding to the specified block number and channel number. Next, in step S402, the value channel selection unit 118 acquires values in the data decompression column 505 and the channel storage destination column 506 in the searched row. Next, in step S403, the value request reception unit 117 specifies the requested value number as well as TRUE/FALSE of data decompression and the channel storage destination acquired in step S402 to request the value acquisition unit 121 to acquire an event value.

Next, in step S404, the value acquisition unit 121 refers to the acquired TRUE/FALSE of data decompression to determine whether data of the value channel has been decompressed. If the data of the value channel has already been decompressed (YES in step S404), the operation proceeds to step S407. If not (NO in step S404), then in step S405, the value acquisition unit 121 requests the data decompression unit 119 to decompress the data of the value channel. Upon receiving the request for data decompression, the data decompression unit 119 decompresses the data of the value channel and stores the decompressed value channel in a file. More specifically, in step S406, the data decompression unit 119 sets TRUE and a file name in the data decompression column 505 and the channel storage destination column 506 of the value channel list 126, respectively.

Next, in step S407, the value acquisition unit 121 initializes a value of the value counter 124 to 0. The structured document analysis apparatus 100 executes the following processing (steps S408 to S410) on all the values of the requested value channel. First, in step S408, the value acquisition unit 121 acquires a single value from the value channel and adds 1 to the value counter 124. Next, in step S409, the value acquisition unit 121 determines whether the requested value number and the value of the value counter 124 match each other. If the requested value number and the value of the value counter 124 do not match each other (NO in step S409), the operation proceeds to step S410. In step S410, the value acquisition unit 121 determines whether all the values in the value channel have been processed. If not all the values in the value channel have yet been processed (NO in step S410), the operation returns to step S408 to process the values that have not been acquired yet. If all the values in the value channel have been processed (YES in step S410), the operation proceeds to step S411. If the requested value number and the value of the value counter 124 match each other (YES in step S409), then in step S411, the value acquisition unit 121 notifies the value notification unit 120 of the acquired value. Next, the structured document analysis apparatus 100 ends the processing illustrated by the flow chart of FIG. 7.

Thus, according to the present exemplary embodiment, when the structured document 141 has a compressed structure channel, the structured document analysis apparatus 100 decompresses the structure channel. In addition, the structured document analysis apparatus 100 generates the event list 125 including structure information (events) of the structured document 141 and reference information (block numbers, channel numbers, and value numbers) that refers to values, to notify an application program of contents of the information. Subsequently, when the application program issues a request for a value and if the value has not been decompressed, the structured document analysis apparatus 100 decompresses the value and notifies the application program of the decompressed value. Thus, when analyzing a compressed XML document (e.g., a document in EXI compression format), the structured document analysis apparatus 100 can decompress only the data portion needed by the application program when needed. Namely, when analyzing a compressed XML document, the structured document analysis apparatus 100 does not need to intensively execute high load processing of decompressing data of the entire XML document. Further, the structured document analysis apparatus 100 can decompress only the data portion relating to necessary values, while the application program is grasping the structure of the XML document. Thus, the structured document analysis apparatus 100 does not execute unnecessary data decompression. Therefore, XML document analysis processing can be executed at a higher speed, and used amounts of used resources such as the memory and the CPU can be reduced. These effects are particularly beneficial when small devices with limited resources, such as digital cameras, execute analysis of a compressed XML document.

In the first exemplary embodiment, for example, the event column 601 indicates an example of the structure information; the block number column 602 and the channel number column 603 indicate an example of identification information about the value data groups; and the value number column 604 indicates an example of identification information about the value data. Further, for example, a structure analysis unit executes the processing of step S205 of FIG. 5 (or the flowchart of FIG. 6), and a structure notification unit executes the processing of step S208. Further, for example, a value selection unit and a value acquisition unit execute the processing of step S210 of FIG. 5 (more specifically, for example, the value selection unit executes the processing of step S402 of FIG. 7, and the value acquisition unit executes the processing of steps S406, S408, and S409). Further, for example, a value notification unit executes the processing of step S211 of FIG. 5.

Next, a second exemplary embodiment of the present invention will be described. The first exemplary embodiment has been described based on an example where the value acquisition unit 121 acquires values and notifies a user application (e.g., an application program) of the acquired values without change. However, in a structured document in EXI compression format, if a value that an event refers to is of a character string type, a value channel may include, instead of a character string, an index number of a character string table generated during analysis processing. Thus, the second exemplary embodiment will be described based on an example where a value that an event refers to is an index number of a character string table. The second exemplary embodiment is mainly different from the first exemplary embodiment about part of the value acquisition processing (see step S210 of FIG. 5). Thus, identical portions between the first and second exemplary embodiments are denoted by the identical reference characters used in FIGS. 1 to 7, and detailed description thereof will not be repeated.

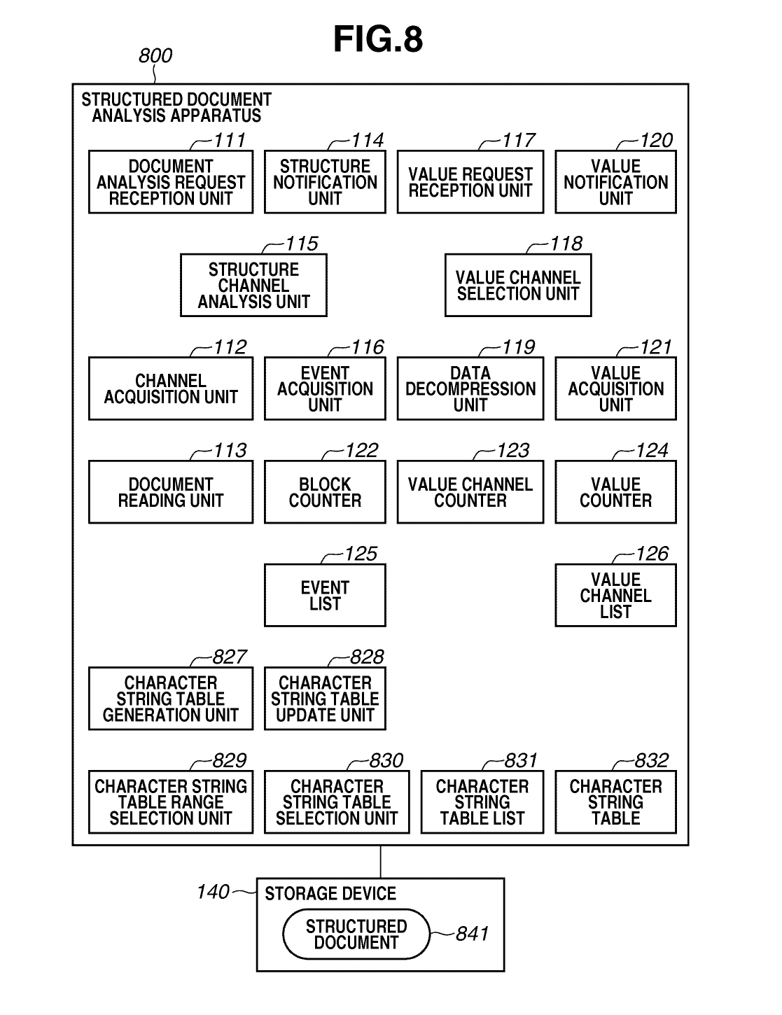

FIG. 8 is a block diagram illustrating a configuration of a structured document analysis apparatus 800. In FIG. 8, the structured document analysis apparatus 800 includes a CPU, a memory, an input unit, a display unit, a communication unit, and the like (not illustrated). The storage device 140 stores a compressed structured document 841 to be analyzed. The memory includes the following units, in addition to those illustrated in FIG. 1. More specifically, the structured document analysis apparatus 800 includes: a character string table generation unit 827 generating character string tables, and a character string table update unit 828 updating character string tables. In addition, the structured document analysis apparatus 800 includes a character string table range selection unit 829 selecting a value channel range registered in a character string table during analysis processing.

In addition, the structured document analysis apparatus 800 includes a character string table selection unit 830 selecting a single character string table from among a plurality of character string tables. Further, the memory in the structured document analysis apparatus 800 includes a character string table list 831 in which a list of character string tables is registered. Furthermore, the memory includes a character string table 832 in which a correspondence between a character string and a reference number thereof is registered.

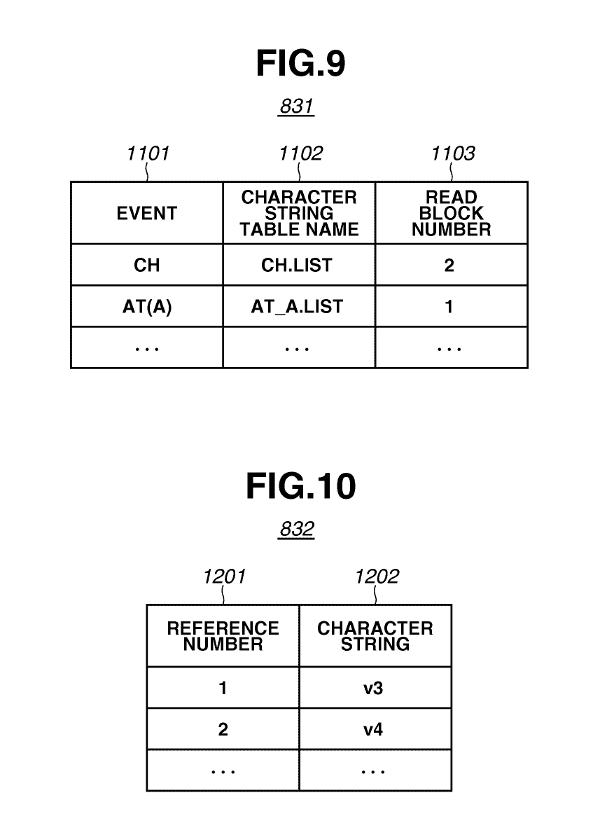

FIG. 9 illustrates the character string table list 831. The character string table list 831 includes an event column 1101 indicating events each referring to respective values. Based on a structured document in EXI format, a character string table 832 is generated for each event. If an event has a single character string table 832, a plurality of rows does not need to be generated for a character string table, as illustrated in FIG. 9. In addition, the character string table list 831 includes a character string table name column 1102 indicating the name of each character string table 832. In FIG. 9, file names are used in the character string table name column 1102. However, arbitrary information may be used in the character string table name column 1102, as long as storage locations can be identified. For example, file pointers, memory addresses, or URLs may be used.

Further, the character string table list 831 includes a read block number column 1103 indicating up to which block number to which value channels belong the character string table list 831 reads and registers in the character string table 832. In the character string table list 831, information in the above columns 1101, 1102, and 1103 is mutually associated and registered. To be more exact, based on a structured document in EXI format, there are two types of character string tables for CH (element content) events: a global character string table in which character strings throughout the entire document are registered; and a local character string table in which character strings relating to part of the document are registered. However, since processing relating to acquisition of character string type values is substantially the same between both of the tables, detailed description of the local character string table will be omitted.

FIG. 10 illustrates the character string table 832. FIG. 10 illustrates a character string table 832 generated for a CH (element content) event during processing of analysis of the structured document of FIG. 2. The character string table 832 includes a reference number column 1201 including reference numbers corresponding to character strings registered in a character string column 1202. In the character string table 832, information in these columns 1201 and 1202 is mutually associated and registered.

Since an overall flow of the document analysis processing executed by the structured document analysis apparatus 800 is the same as that illustrated in FIG. 5, detailed description thereof will not be repeated.

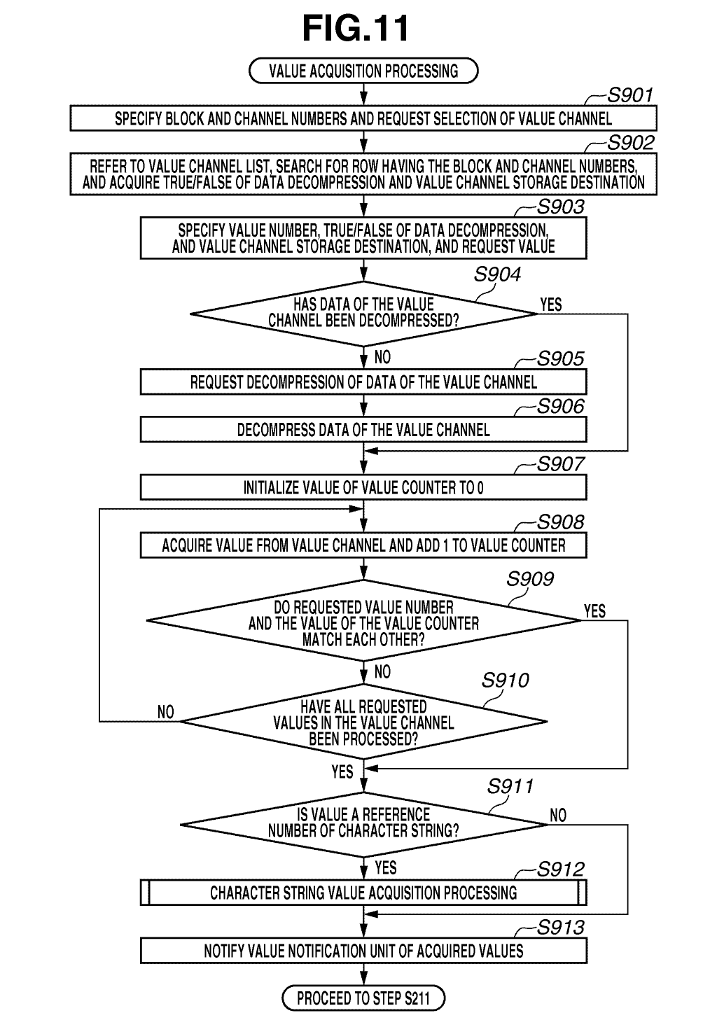

Next, the value acquisition processing in step S210 of FIG. 5 will be described in detail with reference to the flow chart of FIG. 11. Since steps S901 to S910 of FIG. 11 are the same as steps S401 to S410 of FIG. 7, detailed description thereof will not be repeated. In step S911, the value acquisition unit 121 determines whether the acquired value is a reference number of a character string. If the acquired value is not a reference number of a character string (NO in step S911), as in the first exemplary embodiment, then in step S913, the value acquisition unit 121 notifies the value notification unit 120 of the acquired value. On the other hand, if the acquired value is a reference number of a character string (YES in step S911), then in step S912, the structured document analysis apparatus 800 executes character string value acquisition processing, and the operation proceeds to step S913.

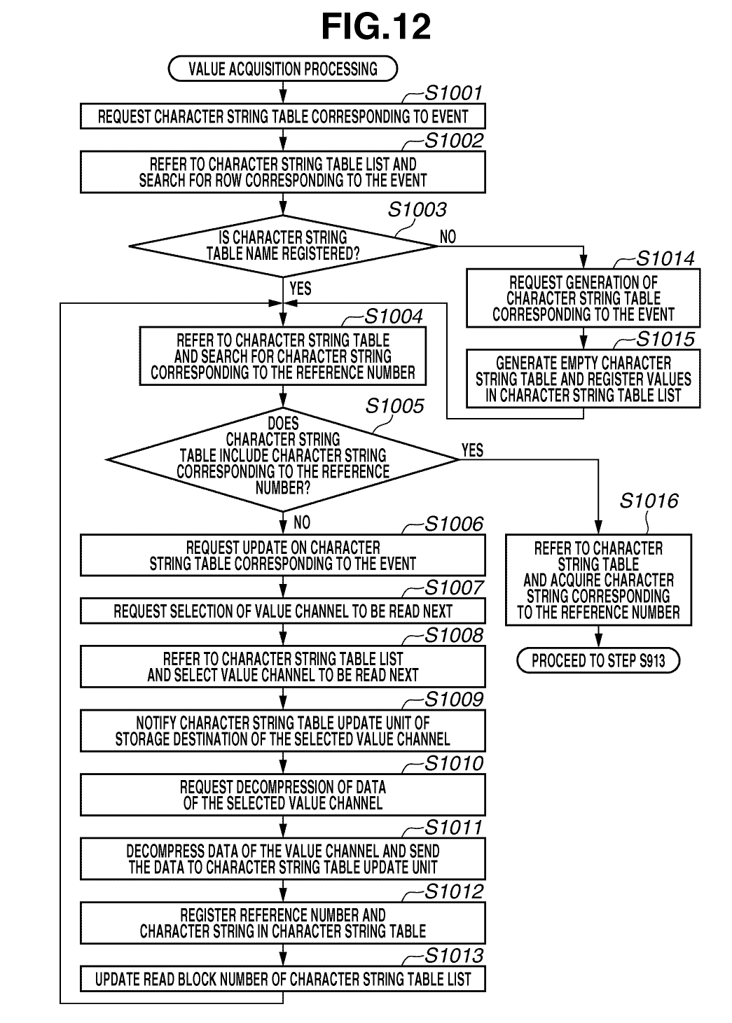

Next, the character string value acquisition processing in step S912 of FIG. 11 will be described in detail with reference to the flow chart of FIG. 12. First, in step S1001, the value acquisition unit 121 specifies an event and requests the character string table selection unit 830 to select a character string table corresponding to the event. For example, the event is obtained from the value channel list 126, that is, from the event column 503 corresponding to the value channel requested in step S901. In step S1002, the character string table selection unit 830 refers to the character string table list 831 and searches for a row in which the value of the event column 1101 matches the specified event. In step S1003, the character string table selection unit 830 refers to the character string table name column 1102 in a row in which the value of the event column 1101 and the specified event match each other, to determine whether a character string table name is registered. If a character string table name is registered (YES in step S1003), the operation proceeds to step S1004. If not (NO in step S1003), the operation proceeds to step S1014.

In step S1014, the character string table selection unit 830 requests the character string table generation unit 827 to generate a character string table corresponding to the specified event. In step S1015, the character string table generation unit 827 generates an empty character string table and registers the name of the specified event, the name of the empty character string table, and the value of the read block number (initial value 0) in the character string table list 831. Next, the operation proceeds to step S1004. The structured document analysis apparatus 800 executes the following processing (steps S1004 to S1013) until the corresponding reference number is found in the registered character string table 832 determined in step S1003 or in the character string table 832 generated in step S1015.

First, in step S1004, the value acquisition unit 121 refers to the character string table 832 and searches for a character string corresponding to the reference number. Next, in step S1005, the value acquisition unit 121 determines whether the character string table 832 includes a character string corresponding to the reference number. If such character string is found (YES in step S1005), then in step S1016, the value acquisition unit 121 acquires the character string, and the structured document analysis apparatus 800 ends the processing illustrated by the flow chart of FIG. 12. On the other hand, if no such character string is found (NO in step S1005), then in step S1006, the value acquisition unit 121 requests the character string table update unit 828 to update the character string table 832 corresponding to the event.

In step S1007, the character string table update unit 828 requests the character string table range selection unit 829 to select a value channel that needs to be reflected in the character string table 832. In step S1008, the character string table range selection unit 829 refers to the character string table list 831 and the value channel list 126 to compare the lists 831 and 126. Based on results of the comparison, the character string table range selection unit 829 selects a value channel to be read next. For example, a value channel that corresponds to an event identical to the specified event and that belongs to a block having a block number next to that in the read block number column 1103 may be selected. Next, in step S1009, the character string table range selection unit 829 refers to the value channel list 126 and notifies the character string table update unit 828 of the channel storage destination 506 of the selected value channel. In step S1010, the character string table update unit 828 requests the data decompression unit 119 to decompress data of the selected value channel.

Next, in step S1011, the data decompression unit 119 decompresses data of the specified value channel and sends the data to the character string table update unit 828. Next, in step S1012, the character string table update unit 828 sequentially acquires values from the value channel. When the values are of a character string type and an actual character string is described, the character string table update unit 828 registers a new reference number in the reference number column 1201 and the character string in the character string column 1202 of the character string table 832. Next, in step S1013, the character string table update unit 828 updates the read block number in the read block number column 1103 of the character string table list 831 to the block number actually read. Thus, even when a value to which an event refers is an index number of a character string table, according to the second exemplary embodiment, the same effect described in the first exemplary embodiment can be provided.

In the second exemplary embodiment, for example, the character string table 832 is an example of a vocabulary table, and the character string table list 831 is an example of a vocabulary table list. Further, for example, the memory is an example of a vocabulary table storage unit and an example of a vocabulary table list storage unit. Further, for example, the event column 1101 indicates an example of structure information, the character string table name column 1102 indicates an example of vocabulary table identification information, and the read block number column 1103 indicates an example of registered data identification information. Further, for example, the character strings registered in the character string column 1202 of the character string table 832 indicate an example of value data. Further, for example, a determination unit executes the processing of step S911 of FIG. 11. Further, for example, a vocabulary table reading unit executes the processing of steps S1002 to S1004 of FIG. 12, and a second determination unit executes the processing of step S1005. Further, for example, a vocabulary table range selection unit executes the processing of step S1008, a vocabulary table updating unit executes the processing of step S1012, and a second value acquisition unit executes the processing of step S1016.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-285688 filed Dec. 16, 2009, which is hereby incorporated by reference herein in its entirety.

What is claimed is:

1. A structured document analysis apparatus for analyzing a compressed structured document including a structure data group having structure information of the document and a value data group having value data corresponding to the structure information, the structured document analysis apparatus comprising:
a structure analysis unit configured to decompress the structure data group to acquire the structure information;
a structure notification unit configured to notify software that processes the structured document of the structure information and reference information that refers to the value data;
a value selection unit configured to select, when the software specifies the structure information and the reference information and requests the value data, a value data group of the structured document based on the specified information;
a value acquisition unit configured to decompress the value data group selected by the value selection unit to acquire value data; and
a value notification unit configured to notify the software of the value data acquired by the value acquisition unit.

2. The structured document analysis apparatus according to claim 1, further comprising:
a vocabulary table storage unit configured to store a vocabulary table in which value data and reference information about the value data are mutually associated and registered;
a determination unit configured to determine whether the value acquisition unit has acquired reference information about value data;
a vocabulary table reading unit configured to read a vocabulary table stored in the vocabulary table storage unit when the value acquisition unit acquires reference information about value data; and
a second value acquisition unit configured to acquire value data corresponding to reference information acquired by the value acquisition unit from a vocabulary table read by the vocabulary table reading unit,
wherein the value data group of the structured document includes, instead of the value data, reference information about value data,
wherein the value acquisition unit decompresses the value data group selected by the value selection unit to acquire reference information about value data, and
wherein the value notification unit notifies the software of the value data acquired by the second value acquisition unit when the value acquisition unit acquires the reference information about value data.

3. The structured document analysis apparatus according to claim 2, further comprising:
a vocabulary table list storage unit configured to store a vocabulary table list in which identification information about the vocabulary table and registered data identification information that identifies value data registered in the vocabulary table are mutually associated and registered;
a second determination unit configured to determine whether data corresponding to reference information acquired by the value acquisition unit is registered in a vocabulary table read by the vocabulary table reading unit;
a vocabulary table range selection unit configured to select value data to be registered in a vocabulary table read by the vocabulary table reading unit based on the registered data identification information, when data corresponding to reference information acquired by the value acquisition unit is not registered in a vocabulary table read by the vocabulary table reading unit; and
an update unit configured to decompress the value data selected by the vocabulary table range selection unit, mutually associate the decompressed data with reference information about the value data, and register the decompressed data and the reference information in the vocabulary table.

4. The structured document analysis apparatus according to claim 3, wherein the structure information is additionally associated and registered in the vocabulary table, and
wherein the vocabulary table reading unit selects a vocabulary table corresponding to structure information identified based on reference information specified by the software from the vocabulary table list, when the value acquisition unit acquires the reference information about value data.

5. The structured document analysis apparatus according to claim 3, wherein value data registered in the vocabulary table is a character string.

6. The structured document analysis apparatus according to claim 3, wherein the structured document is a structured document in Efficient Extensible Markup Language (XML) Interchange (EXI) compression format of the World Wide Web Consortium (W3C),
wherein the registered data identification information includes a block number to which a value channel registered in the vocabulary table belongs, and
wherein the vocabulary table range selection unit selects a value channel including value data registered in the vocabulary table, based on comparison between a block number of a value channel including value data of which the software is notified and a block number as the registered data identification information.

7. The structured document analysis apparatus according to claim 1, wherein the reference information includes identification information about the value data group and identification information about the value data.

8. The structured document analysis apparatus according to claim 1, wherein the structured document is a structured document in EXI compression format of the W3C, and
wherein the structure data group is a structure channel and the value data group is a value channel.

9. The structured document analysis apparatus according to claim 1, wherein the structured document is a structured document in EXI compression format of the W3C and the structure information is event information.

10. The structured document analysis apparatus according to claim 1, wherein the structure notification unit notifies the software of structure information and the value notification unit notifies the software of value data through an XML parser application program interface (API), including Simple API for XML (SAX) or Document Object Model (DOM).

11. A structured document analysis method for analyzing a compressed structured document including a structure data group having structure information of the document and a value data group having value data corresponding to the structure information, the structured document analysis method comprising:
decompressing the structure data group to acquire the structure information;
notifying software that processes the structured document of the structure information and reference information that refers to the value data;
selecting, when the software specifies the reference information and requests the value data, a value data group of the structured document based on the specified information;
decompressing the selected value data group to acquire value data; and
notifying the software of the acquired value data.

12. A computer-readable storage medium storing a program for causing a computer to execute the structured document analysis method according to claim 11.
